(19) United States
(12) Patent Application Publication
(10) Pub. No.: US 2011/0129402 A1
(43) Pub. Date: Jun. 2, 2011

(54) Method of producing trichlorosilane (TCS) rich product stably from hydrogenation of silicon tetra chloride (STC) in fluidized gas phase reactor (FBR) and the structure of the reactor

(76) Inventors: Yong Chae Chee, Beverly Hills, CA (US); Tetsunori Kunimune, La Canada, CA (US)

(21) Appl. No.: 12/931,581

(22) Filed: Feb. 4, 2011

Related U.S. Application Data
(62) Division of application No. 12/802,320, filed on Jun. 4, 2010.
Application No. 12/802,320 is a continuation-in-part of application No. 12/456,979, filed on Jun. 25, 2009, now abandoned.
(60) Provisional application No. 61/133,688, filed on Jul. 1, 2008.

(51) Int. Cl. C01B 33/107

(52) U.S. Cl. 423/342

(57) ABSTRACT

A fluidized bed reactor (FBR) for producing chlorosilane mixture containing trichlorosilane (TCS) concentration at least 50% from hydrogenation of special metallurgical silicon (MGSI), which has manganese concentration less than 35 ppmw, silicon tetra chloride (STC), and the method of producing high TCS content chlorosilane mixture is disclosed. The FBR according to current application has an expanded over head zone, whose inner diameter is at least twice bigger than that of the inner diameter of the lower straight zone. Temperature of the reaction bed is controlled between 300° C. to 600° C. within the mean temperature deviation of ±5 C. Reaction pressure is maintained between 3 to 10 bar. Retention time of the STC and hydrogen in the reaction bed is controlled to be shorter than 30 seconds. The FBR of the current application enables higher STY (space time yield; production rate/volume of the reactor) of TCS compared to any other current commercial STC cold converter, which hydrogenise STC to TCS.

This is a divisional application of U.S. patent application Ser. No. 12/802,320, which is Continuation In Part of the U.S. patent application Ser. No. 12/456,979, which is now abandoned and which was non-provisional application of the Provisional Application No. 61/133,688 which was filed on Jul. 1, 2008.

### FIELD OF THE INVENTION

### Background of the Invention

Most of polysilicon for solar cell is produced by CVD (Chemical Vapor Deposition) reactor to deposit TCS on pure silicon rod at a temperature around 1,100° C., “Siemens Process”. However, lots of TCS turned into STC in the CVD reactor due to the HCl, which is produced from hydrogen-dechlorination of TCS, reacts again with TCS and produce STC. The amount of STC produced from the CVD reactor is about 15 MT of STC/1 MT polysilicon. Due to such huge amount, some small plants were shut down. Thermal converter, for hydrogenation of those STC at high temperature, has been commercially used for the “Siemens Process.” However, the conversion rate of STC to TCS from the thermal converter is only 20% around and it spends lot of electricity to maintain the reactor temperature around 1,000° C. Other means of converting STC to TCS is hydrogenation of STC in the presence of MGSI. This method operates around 500° C. But, the operation pressure is about 30 bar and the production rate and conversion is unstable below 35% and the STY is very low because of the low gas inlet velocity to maintain conversion rate. It is purpose of the current application to provide a reliable means to convert STC to TCS at a lower pressure, high conversion rate above 50% and high STY at the same time.

### DESCRIPTION OF THE PRIOR ART

U.S. Pat. No. 2,595,620 to Wagner, et al. illustrates hydrogenation of halogenosilanes, especially hydrogenation of silicontetrachloride (STC) in the presence of MGSI (metallurgical grade silicon) based on the assumption as the following equations.

3SiCl₄+Si+2H₂→4SiHCl₃

Reaction at a various temperatures between 400° C. and 500° C. were investigated. For atmospheric pressure, the concentration of TCS in the −78° C. condensed product from the reactor shows less than 25%. The TCS concentration increased with the retention time of STC and hydrogen in the reactor. This means the conversion depends on the ratio of bed height/SGV (specific gas velocity). In other words, the conversion of STC to TCS is higher when the bed height is higher and the feed rate of the gaseous reactants, hydrogen and STC, is lower. So, the over all production rates of TCS per volume is very low. Maximum concentration of TCS, 36%, was observed when the reaction pressure is 1,000 Pisa and retention time was 2.9 minutes. However, to maintain such conversion constantly, the height of the bed and the SGV of the gaseous reactants must be controlled. To control the bed height, the fluidized bed must be operated smoothly without channeling or slugging. In addition to this, the STY of this reaction system is very low to maintain high conversion rate by keeping long retention time. U.S. Pat. No. 4,676,967 to Breneman, et al. illustrates a process for the production of ultra high purity silane and silicon. Metallurgical silicon is initially reacted with hydrogen and silicon tetrachloride in a reaction zone maintained at a temperature of from about 400° C. to about 600° C. and at a pressure in the range of from about 300 to about 600 psi, to form trichloro-silane as follows;

3SiCl₄+2H₂+Si→4HSiCl₃ (1)

with the reaction (1), mixture containing a yield of about 20˜30% by weight trichlorosilane on a hydrogen-free basis, and of about 0.5% dichlorosilane with the remainder being silicon tetrachloride together with impurities comprising mainly carryover metallurgical silicon powder, hydrogen chloride, metal halides essentially without undesired polysilanes were obtained. None of the method is disclosed therein to control the bed height and retention time.

PCT international publication No. WO2007/035106 to Andersen, et al. illustrates a method for the production of TCS (Trichlorosilane) by reaction of silicon, STC (Silicontetrachloride) and hydrogen gas at a temperature between 400° C. to 800° C. and at a pressure of 0.1 to 30 bar in a fluidized bed reactor, in a stirred bed reactor or in a solid bed reactor with MGSI containing manganese less than 50 ppmv. The MGSI with low manganese produced TCS over the conversion rate of 50%, which is higher than the known equilibrium conversion of 45% maximum. Generally to reach the equilibrium, the contact time must be longer. However, in this case they got conversion over 50% at a contact time is less than few seconds. It is totally contrary of the entire previous STC converter. Among the three types of reactors referred in the WO2007/035106, FBR is the best reactor type to realize uniform reaction condition if properly designed.

Even though the inventors claim that they used a FBR, it is a small laboratory scale reactor and their SGV is about 1 cm/sec. At this SGV, the MGSI bed does not move. The MGSI bed just expands. It is named as an ‘expanded bed’ (Fluidization Engineering, John Wiley & Sons, Inc., pp 1˜3, Daizo Kuni and Octave Levenspiel).

In other words, they tested the gas-solid reaction in some reactor, not in a real FBR (fluidized bed reactor). However, it is normal for testing a new reaction at early stage of technology development because running an unknown new reaction in a FBR directly is dangerous due to the scale of reactants, toxic gases, used.

Anyway, they found a reaction that behaves quite differently from all of the previous result that the reaction of hydrogenation of STC in the presence of MGSI is a slow equilibrium reaction and has a limitation of maximum conversion. But, their result is that even at the slow SGV, the contact time of the STC and hydrogen with the special MGSI is less than a second and the conversion is over 50%. It means the reaction is very fast and the mechanism is different. However, they did not disclose how to scale up and apply the invention to commercial scale of tens of thousand of TCS production by hydrogenation of STC.

The applicants of the current invention already developed a FBR reactor for very fast exothermic reaction of direct hydro chlorination of MGSI in a commercial scale, above 20,000 MT/YR TCS. The commercial scale FBR shows much stable operation than any other STC hydrogenation reactor and produce crude TCS with 95% purity among the liquefied products directly from the FBR.

It is the purpose of the current application to provide an industrially practical FBR to convert STC to TCS by reacting STC, hydrogen and MGSI at a lower pressure and high out put rate, STY.

It is another purpose of the current application to provide a method of producing TCS stably by hydrogenation of STC with the FBR disclosed.

Many preliminary works have been done to find the optimized structure of the FBR and the method of operation of the FBR.

### DESCRIPTION OF THE DRAWINGS

FIG. 1 is a perspective view of a cold fluidized bed to optimize the ‘Operating Bed Height’ of the solid materials.

FIG. 2 is an elevated view of a gas distributor used in the cold fluidized bed according to current application.

FIG. 3 is a side cross sectional view of the fluidized bed reactor for stable production of trichlorosilane by hydrogenation of STC in the presence of special grade metallurgical silicon according to current application.

FIG. 4 is a prior art that shows the cross-sectional view of “A” part in the FIG. 3.

FIG. 5 is a cross sectional view of the new gas distributor designed according to current invention.

### DETAILED DESCRIPTION OF THE PREFERRED EMBODIMENT OF THE INVENTION

Fluidized Bed Reactor (FBR) is selected for maximum mixing of ‘fluidizing bed materials.’ That enables uniform reaction condition inside of the ‘fluidizing bed.’

Among the various stage of the FBR, ‘slugging bed’ is known as ‘must be avoided’ because of their unstable bed behavior and many ‘entrainment of bed material’ to the exit gas stream (Fluidization Engineering, John Wiley & Sons, Inc., pp 1˜3, Daizo Kuni and Octave Levenspiel). When the phenomenon ‘slugging’ happens, the upper part of the gas-solid bed is pushed up-ward and is separated from the main bed. Therefore, when the ‘bed’ is operated as ‘slugging mode’, the heat transfer within the bed and between the bed and reactor wall surface decreases because the heat transfer coefficient of gas is normally lower than that of the solid material. This phenomenon is typical in a gas-solid FBR.

It is naturally concluded that maintaining the ‘bed’ of the reactant in a ‘bubbling bed’ mode is the first thing to be resolved because none of the prior arts disclosed what is the parameter that categories the boundary of ‘bubbling bed.’

### Determining “Bubbling Bed” Condition.

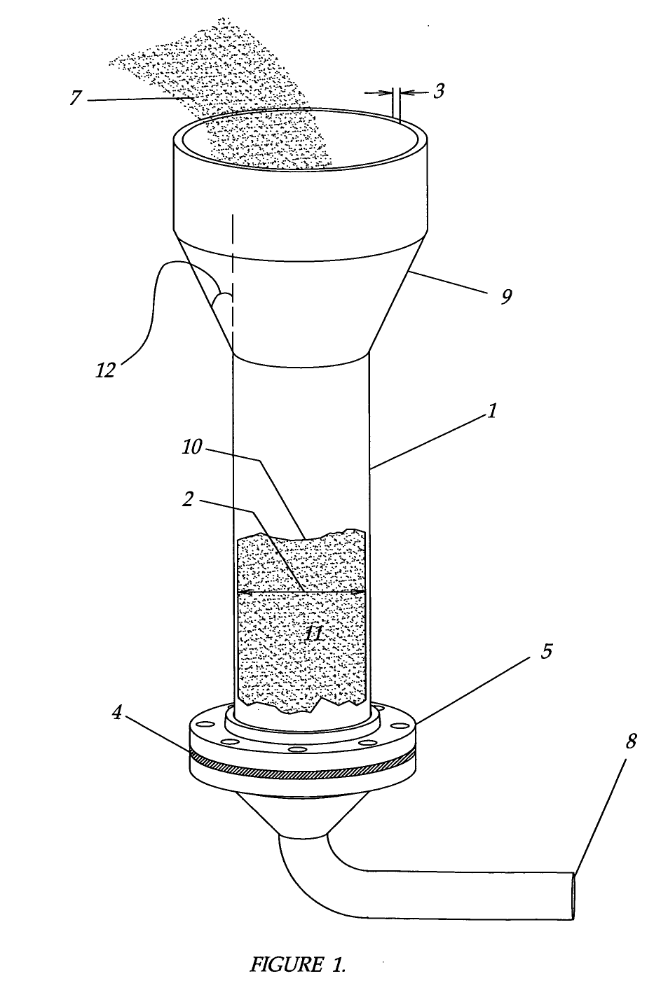

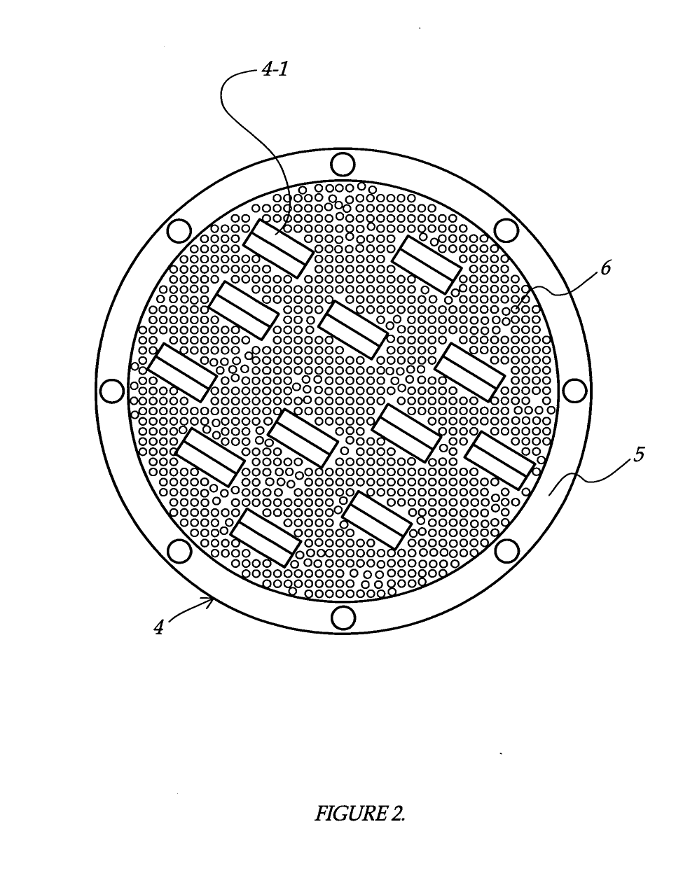

The applicant started from this point with a transparent cold bed of a FBR as shown in the FIG. 1. The lower portion (1) of the cold bed FBR is made of transparent PMMA (polymethylmethacrylate) pipes of inner-diameter (2), d₁, of 15 cm. Wall thickness (3) of the lower portion is 1 cm to hold the bed weight. Bottom of the lower portion (1) is supported by a gas distributor (4) and fastened via a flange (5) as shown in the FIG. 2. The gas distributor (4) is made of a perforated stainless 304 plate of 1 cm thick. Pluralities of 1 mm to 5 mm diameter holes (6) are evenly developed across the whole gas distributor (4) and pluralities of chevron type gas hole caps (4-1) covers the holes (6). Inside of the lower portion (1) of the cold bed FBR is filled with dry sands (7) within particle diameter range of 150 to 200 micrometer. The sands were dried in an oven which is maintained at 400° C. for over night under nitrogen atmosphere (evaporated liquid nitrogen; 99.999%) to drive out the moisture soaked therein. The dried sands (7) were cooled to room temperature under the same nitrogen atmosphere. The cold bed FBR was purged with the same nitrogen over night. The cooled sands (7) are charged to the lower portion (1) of the cold bed FBR from the above while the FBR is slightly purging with the nitrogen. Bulk density of the dried sand (7) was 0.98 to 1.02 g/cc. Height of the sand (7) bed was varied as shown in the table 1. Nitrogen (8) vaporized from a 200 liter liquid nitrogen container was compressed and used as the fluidizing medium. Specific gas velocity of the nitrogen in the lower portion (1) of the FBR was varied from 10 cm/sec to 30 cm/sec.

TABLE 1

| H/d₁* | SGV** | |
|---|---|---|
| (initial) | (Cm/sec) | Slugging*** |
| 1 | 10 | No |
| | 20 | No |
| | 30 | No |
| 2 | 10 | No |
| | 20 | No |
| | 30 | No |
| 3 | 10 | Yes, Slight |
| | 20 | Yes, moderate |
| | 30 | Yes, |
| 4 | 10 | Yes |
| | 20 | Yes, bed unstable |
| | 30 | Yes, particles blow out |
| 5 | 10 | Yes, particles blow out |
| | 20 | Yes, particles blow out |
| | 30 | Yes, particles blow out |
| 6 | 10 | Yes, becomes entrained |
| | 20 | Yes, entrained |
| | 30 | Yes, severe entrain |

*H is the height of the sand bed charged initially, d₁ is the inner diameter of the Lower portion of the FBR.
**SGV is the specific gas velocity of nitrogen in the bed.
***Slugging is a phenomenon that the fluidizing bed is separated in two zones.

The applicant found from his long experience of FBR operation that relative value of the ‘height of the fluidized bed of the solid particles’ and ‘internal diameter of the fluidizing vessel’ is the key parameter that categorize the boundary of ‘bubbling bed’ and ‘slugging bed.’ However, the ‘height of the fluidized bed of the solid particle’ varies depends on the SGV. So, ‘initial bed height of the charged solid particles’ is selected as one parameter.

As shown in the table 1, the ‘slugging’ does not occur within the SGV range lower than 30 cm/sec until the ‘initial bed height of the charged solid particles’ (H)/‘inner diameter of the fluidizing vessel’ (d₁) reaches over 2. At the level of H/d₁=2, the ‘height of the fluidized bed of the solid particles’ reaches five times of the vessel's inner diameter, d₁, when SGV is 30 cm/sec. When H/d₁ is higher than 3, slugging starts even at SGV of 10 cm/sec. At this moment, the ‘height of the fluidized bed of the solid particles reached around six times of the inner diameter of the fluidizing vessel. Upper section of the ‘fluidized bed of the solid particles’ is separated from the rest of the bed and is raised higher followed by collapse of the separated portion. As the H/d₁ is higher than 4, ‘slugging’ accompanied with ‘entrainment’. So, the solid particles come out of the FBR.

The meaning of the above finding is that if some FBR operates with initial bed height charged higher than 4 times of the inner diameter, the possibility of ‘slugging’ the bed is very high even at the lower SVG of 10 cm/sec. Then mixing in the FBR reactor is not good and the reaction inside of the reactor is non-uniform. In other words, the reactor is not under control.

The other founding is that, when the slope of the expending section (9) is low, particles that leave the top surface (10) of the fluidized bed (11) accumulate on the inner surface of the expanding section (9). By trial and error, it was found that the angle (11) of the slope of the expanding section (9) from a vertical line should be smaller than 7 degrees.

### Design of the FBR

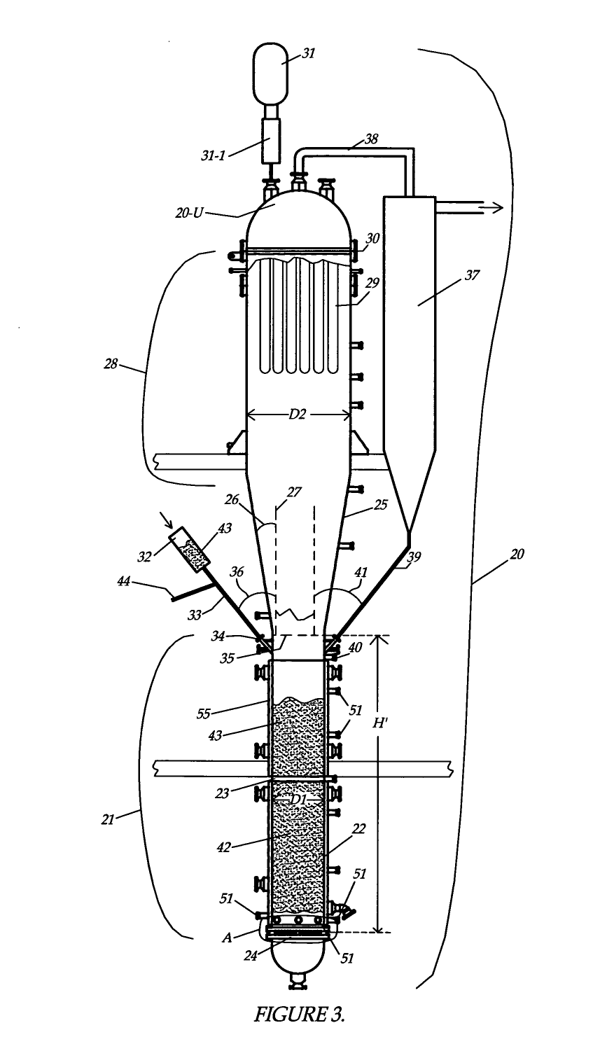

Based on the above findings, the FBR (fluidized bed reactor) (20) for STC conversion to TCS, according to current application, is designed as shown in the FIG. 3.

The key features of the FBR (20) according to current application are as follows;
In the lower reactor section (21) of the FBR (20), the ratio of the height of the straight zone (H′) over internal diameter (D₁) is fixed between three to six.
Cooling/heating jacket (22) surrounds the outer surface (23) of the lower reactor section (21).
A gas distribution plate (24), which has pluralities of small holes and chevron hole caps as shown in the FIG. 3, is installed at the bottom of the lower reactor section (21).
Expanding zone (25) maintains an angle (26) from a vertical line (27), which is extended from the wall of the lower reactor section, smaller than 7 degrees and expands until the inner diameter (D₂) of the upper reactor section (28) reaches over two times of the inner diameter (D₁) of the lower reactor section (21).
An internal cooler (29) is optionally installed inside of the upper reactor section (28) via a flange (30) for easy replacement of eroded cooler (29).
An initial charging material hopper (31) is installed at the top of the upper reactor section to dump-out the initial charging material into the FBR (20) at the start up.
A powder feeder, MGSI feeder, (32) is connected to the FBR (20) via a feeding line (33) that reaches a point (34) just below the upper end (35) of the lower reactor section (21) with an angle (36) from a vertical line, which is extended from the wall of the lower reactor section, smaller than 20 degrees. The powder feeder (32) controls feeding rate of the silicon at a range of 1 Kg/hr to 1,000 Kg/hr with ±5% deviation at a pressure of 150 Pisa.
A cyclone (37) is connected to the FBR (20) via an exit gas line (38) from the top of the FBR (20) and via a recycling line (39) that reaches a point (40) just below the upper end (35) of the lower reactor section (21) with an angle (41) from a vertical line smaller than 20 degrees.
Another powder feeder, initial charging material feeder, (31-1) which controls feeding rate of the silicon at a range of 1 Kg/hr to 1,000 Kg/hr with ±5% deviation at a pressure of 150 Pisa, is installed between the initial charging material hopper (31) and the FBR (20)
Pluralities of thermocouples (51), 2 to 36, are installed along the brim of the gas distribution plate (24), and 2 to 36 thermocouples are installed along the height of the FBR (20). The temperature reading tells real-time information inside of the FBR (20).

For producing TCS rich silane mixture by the hydrogenation of STC in the presence of a special MGSI, which has manganese concentration less than 35 ppmw, the FBR (20) is operated as follows;

The FBR (20) is purged with vaporized liquid nitrogen properly before start up. The reactor is filled with proper initial charging materials (42), including but not limited with, non-porous silica or porous silica, such as Grace Davison 952, quartz powder, amorphous quartz powder, sand, zirconia or equivalent. Those materials should have elemental Si contents at least 99.8 wt %. Particle size, true density, and bulk density of the seed bed material is almost equivalent to that of the metallurgical silicon as shown in the Table 2.

TABLE 2

| Properties | |
|---|---|
| Particle size | 100~150 |
| Bulk Density (g/cc) | 0.98~1.02 |
| True Density (g/cc) | 1.98~2.01 |
| SiO₂ content (wt %) | >99.8 |

Amount of initial charging material (42) introduced at the start up should be enough to fill the height (H) of the lower reactor section (21) with the dimension that is equivalent to one to three times of the internal diameter (D₁) of the lower reactor section.

The FBR (20) system is purged and fluidized with vaporized liquid nitrogen introduced to the initial charging material (42) bed from the bottom through the gas distribution plate (24) at 100° C. in a ‘bubbling bed’ mode until the effluent gas contains moisture less than 0.1 ppm.

Then, the initial charging material (42) bed temperature is increased up to 500° C. Then nitrogen is switched to hydrogen mixed with vaporized STC while maintaining the total SGV of the gas mixture over 30 cm/sec. At the same time special metallurgical grade silicon particles, which has manganese contents lower than 10 ppmw, (43) are introduced to the initial charging material (42) bed through the silicon feeding line (33), which reaches a point (34) just below the upper end (35) of the lower reactor section (21) with an angle (36) from a vertical line, which is extended from the wall of the lower reactor section, smaller than 20 degrees.

The MGSI feeding line (33) is connected to an outer carrier gas feeding line (44). Part of hydrogen gas and/or STC needed is introduced through the carrier gas feeding line (44) and disperses and carries the silicon particles (43) into the bed. Major portion of hydrogen and STC is heated up to 400° C. and introduced to the FBR from the bottom of the FBR through the gas distribution plate (24).

As disclosed in many prior arts, they start up the hydrogenation to convert STC to TCS production with un-necessarily excess amount of silicon. Their usual SGV is around 10 cm/sec to meet the long retention time of over 50 seconds to 60 seconds for maximum conversion. However, at this velocity, which is about 2˜3 times of minimum fluidizing velocity, the bed of silicon just start to swell and does not mix the bed. Then the concentration of gas components, reactants and the produced HCl, does not disperse uniformly across the bed. Especially when the reactor is big, it causes many un-desired reaction. To avoid such unnecessary side reaction, the applicant developed couple of methods as follows.

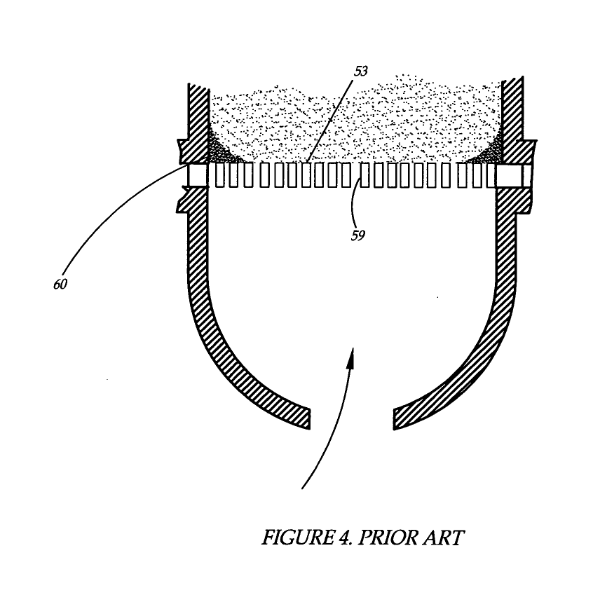

First method is to use inert initial charging material to disperse and mix the reactants, special MGSI, which has manganese concentration less than 35 ppmw, hydrogen and STC, well with high SGV to operate the bed as ‘bubbling bed mode.’ The initial charging material is chemically inert at the reaction environment and the physical properties are same as those of the silicon granule used as reactant. Pure silica (SiO₂) granules, quartz, have almost the same physical properties and showed no chemical reaction at the reaction conditions of 550° C. and at 5 atm pressure. The amount of the initial charging material introduced at the start up is the amount that can fill the height (H) of the lower reactor section with a dimension that is one to six times of the internal diameter (D₁) of the lower reactor section. Second method is to use a feeder that feeds the special MGSI granules continuously with accuracy of ±5% at 105 Pisa. It is well known in this industry that on-off block valve or some ball valves are used in commercial STC to TCS synthesis process. On-off valves provide pulse feeding and ball valves are easily worn out by the silicon granules. Therefore, both valves provide unstable feeding. Then, pulse or unstable feeding of the silicon granules result in ramping of the reactor temperature, due to sudden introduction of cold MGSI, and loose of temperature control. It is clear that the reaction condition becomes unstable and the products composition distribution also unstable according to the unstable temperature control. The third method is the gas distribution plate design. FIG. 4 is a prior art that shows the cross-sectional view of a bottom section of a prior art. Usually the gas distributor (53) is a flat panel with pluralities of gas holes (59). This kind of grid type gas distribution plate is widely used for FBR which is operated at high SGV well over 10 cm/sec, usually up to 60 cm/sec. However, due to the structure, a stationary zone (60) is easily developed at the corner of the distributor (53) and the bottom of the bed. Bed materials do not move in this stationary zone (60).

In case of exothermal reaction, heat generated by the reaction can not be effectively removed by the gas and as a result a ‘hot spot’ is formed. At this ‘hot spot’ the reaction produces non-desirable result, such as high molecular weight siloxane and viscous particles aggregated together.

In case of endothermic reaction, like STC hydrogenation, the heat supplied from outside of the reactor will not be transferred well and the temperature at this stationary zone (60) will be different from the main bed and the product distribution will be different from main bed. Then the efficiency of the bed is decreased.

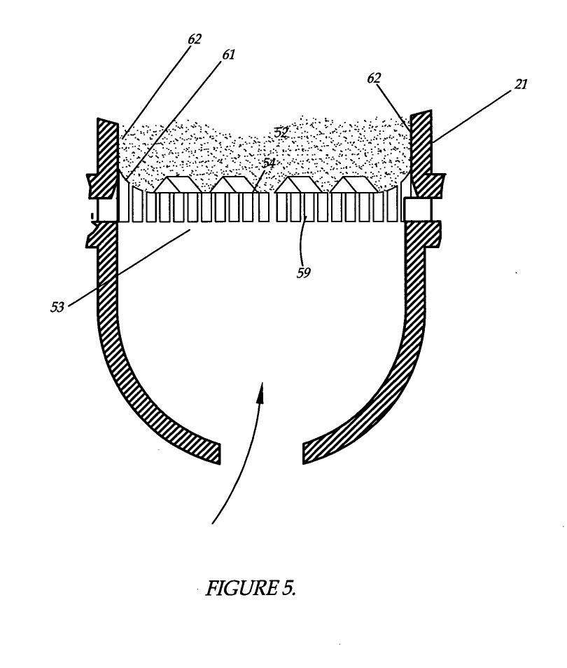

FIG. 5 is a cross sectional view of the new gas distributor (53′) designed according to current invention. The new gas distributor has a brim that has concavely rounded surface (61). Pluralities of chevron shape gas hole caps (54) are developed on the flat upper surface of the new gas distributor (53′). Due to the smoothly rounded inner corner surface (61) between the vertical inner surface (62) of the lower portion (21) of the reactor and the gas distribution plate (53′), the bed (52) circulates naturally along the gas stream. This new gas distributor (53′) will reduce the chance of developing a stationary zone at the bottom of the bed.

By combining the above methods, the applicant can introduce the reactants, gas and solid, stably into the FBR (20).

The initial charging material (42) is inert to the reaction. In addition to that, it helps dispersion of the reactants and products uniformly throughout the fluidizing bed. At the same time the charging material transfers heat between the reactants and to the wall. So, temperature of the ‘fluidizing bed’ becomes uniform too.

With combination of the above methods, the fluidized bed will convert STC to TCS more stably and continuously by maintaining temperature of the reaction bed controlled between 300° C. to 600° C., more specifically at 550° C., within the mean temperature deviation, between thermo couples in the bed, of ±5 C. Reaction pressure is maintained between 3 to 10 bars, more specifically at 5 bars. Contact time between the STC, hydrogen and the special MGSI in the reaction bed is controlled to be shorter than 50 seconds, more specifically less than 30 seconds due to the high SGV and the dilution effect of the initially charging material.

What is claimed is:

1. A method of producing TCS (Trichlorosilane) rich silane gas mixture by hydrogenation of STC (Silicon tetrachloride) in the presence of special MGSI, which has manganese concentration less than 35 ppmw, stably from a FBR (Fluidized Bed Reactor), which is comprised of;
a lower reactor section of the fluidized bed, in which the ratio of the height of the straight zone (H′) over internal diameter (D₁) is fixed as six,
and
a cooling jacket surrounding the outer surface of the lower reactor section,
and
a gas distribution plate, whose brim is rounded concavely to form a smooth round inner surface between the vertical inner surface of the lower reactor section and the gas distribution plate, which is installed at the bottom of the lower reactor section and which is equipped with pluralities of gas holes of diameter 2 mm and pluralities of chevron shape gas hole caps that cover the holes,
and
an upper reactor section,
and
an expanding zone locates between the lower reactor section and the upper reactor section
and
maintains an angle from a vertical line of 7 degree and expands until the inner diameter (D₂) of the upper reactor section reaches two times of the inner diameter (D₁) of the lower reactor section,
and
an internal cooler that is installed inside of the upper reactor section via a flange for easy replacement,
and
an initial charging material hopper that is installed at the top of the upper reactor section to dump in the seed bed material at the start up of the fluidized bed reactor,
and
a MGSI feeder that controls feeding rate of the special MGSI, which has manganese concentration less than 35%, at a range of 1,000 Kg/hr with +5% deviation at a pressure of 150 Pisa and is connected to the fluidized bed reactor via a feeding line that reaches a point just below the upper end of the lower reactor section with an angle from a vertical line smaller than 20 degrees,
and
an initial charging material feeder that controls feeding rate of the initial charging material at a range of 1,000 Kg/hr with +5% deviation at a pressure of 150 Pisa and is connected to the FBR,
and
a cyclone that is connected to the fluidized bed reactor via an exit gas line from the top of the fluidized bed reactor and via a recycling line that reaches a point just below the upper end of the lower reactor section with an angle from a vertical line smaller than 20 degrees,
and
pluralities of thermocouples; four of them are installed along the brim of the gas distribution plate and twelve of them are installed along the height of the FBR to get real-time temperature information inside of the FBR.

2. A method of producing TCS (Trichlorosilane) rich silane gas mixture by hydrogenation of STC (Silicon tetrachloride) in the presence of special MGSI, which has manganese concentration less than 35 ppmw, stably from a FBR (Fluidized Bed Reactor), which is comprised of;
a lower reactor section of the fluidized bed, in which the ratio of the height of the straight zone (H′) over internal diameter (D₁) is fixed as six,
and
a cooling jacket surrounding the outer surface of the lower reactor section,
and
a gas distribution plate, whose brim is rounded concavely to form a smooth round inner surface between the vertical inner surface of the lower reactor section and the gas distribution plate which is installed at the bottom of the lower reactor section and which is equipped with pluralities of gas holes of diameter 2 mm and pluralities of chevron shape gas hole caps that cover the holes,
and
an upper reactor section,
and
an expanding zone locates between the lower reactor section and the upper reactor section
and
maintains an angle from a vertical line of 7 degree and expands until the inner diameter (D₂) of the upper reactor section reaches two times of the inner diameter (D₁) of the lower reactor section,
and
an initial charging material hopper that is installed at the top of the upper reactor section to dump in the seed bed material at the start up of the fluidized bed reactor,
and
a MGSI feeder that controls feeding rate of the special MGSI, which has manganese concentration less than 35%, at a range of 1,000 Kg/hr with +5% deviation at a pressure of 150 Pisa and is connected to the fluidized bed reactor via a feeding line that reaches a point just below the upper end of the lower reactor section with an angle from a vertical line smaller than 20 degrees,
and
an initial charging material feeder that controls feeding rate of the initial charging material at a range of 1,000 Kg/hr with +5% deviation at a pressure of 150 Pisa and is connected to the fluidized bed reactor,
and
a cyclone that is connected to the fluidized bed reactor via an exit gas line from the top of the fluidized bed reactor and via a recycling line that reaches a point just below the upper end of the lower reactor section with an angle from a vertical line smaller than 20 degrees,
and
pluralities of thermocouples; four of them are installed along the brim of the gas distribution plate and twelve of them are installed along the height of the FBR to get real-time temperature information inside of the FBR.

3. A method of producing TCS (Trichlorosilane) rich silane gas mixture by hydrogenation of STC (Silicon tetrachloride) in the presence of special MGSI, which has manganese concentration less than 35 ppmw, stably from the FBR (Fluidized Bed Reactor) of the claim 1 and 2, wherein the expanding zone, locates between the lower reactor section and the upper reactor section, maintains an angle from a vertical line of 7 degrees and expands until the inner diameter (D₂) of the upper reactor section reaches three times of the inner diameter (D₁) of the lower reactor section.

4. A method of producing TCS rich silane gas mixture by hydrogenation of STC in the presence of special MGSI, which has manganese concentration less than 35 ppmw, stably from the FBR of the claim 1 and 2, wherein the ratio of the height of the straight zone (H′) over internal diameter (D₁) is fixed as six.

5. A method of producing TCS rich silane gas mixture by hydrogenation of STC in the presence of special MGSI, which has manganese concentration less than 35 ppmw, stably from the FBR of the claim 1 and 2, wherein the ratio of the height of the straight zone (H′) over internal diameter (D₁) is fixed as five.

6. A method of producing TCS rich silane gas mixture by hydrogenation of STC in the presence of special MGSI, which has manganese concentration less than 35 ppmw, stably from the FBR of the claim 1 and 2, wherein the ratio of the height of the straight zone (H′) over internal diameter (D₁) is fixed as four.

7. A method of producing TCS rich silane gas mixture by hydrogenation of STC in the presence of special MGSI, which has manganese concentration less than 35 ppmw, stably from the FBR of the claim 1 and 2, wherein the ratio of the height of the straight zone (H′) over internal diameter (D₁) is fixed as two.

8. A method of producing TCS rich silane gas mixture by hydrogenation of STC in the presence of special MGSI, which has manganese concentration less than 35 ppmw, stably from the FBR of the claim 1 and 2, wherein the ratio of the height of the straight zone (H′) over internal diameter (D₁) is fixed as one.

9. A method of producing TCS rich silane gas mixture by hydrogenation of STC in the presence of special MGSI, which has manganese concentration less than 35 ppmw, stably from the FBR of the claim 1 and 2, wherein the amount of the initial charging material introduced at the start up is the amount that can fill the height (H) of the lower reactor section with a dimension that is equivalent to the internal diameter (D₁) of the lower reactor section.

10. A method of producing TCS rich silane gas mixture by hydrogenation of STC in the presence of special MGSI, which has manganese concentration less than 35 ppmw, stably from the FBR of the claim 1 and 2, wherein the amount of the initial charging material introduced at the start up is the amount that can fill the height (H) of the lower reactor section with a dimension that is two times of the internal diameter (D₁) of the lower reactor section.

11. A method of producing TCS rich silane gas mixture by hydrogenation of STC in the presence of special MGSI, which has manganese concentration less than 35 ppmw, stably from the FBR of the claim 1 and 2, wherein the amount of the initial charging material introduced at the start up is the amount that can fill the height (H) of the lower reactor section with a dimension that is three times of the internal diameter (D₁) of the lower reactor section.

12. A method of producing TCS rich silane gas mixture by hydrogenation of STC in the presence of special MGSI, which has manganese concentration less than 35 ppmw, stably from the FBR of the claim 1 and 2, wherein the amount of the initial charging material introduced at the start up is the amount that can fill the height (H) of the lower reactor section with a dimension that is four times of the internal diameter (D₁) of the lower reactor section.

13. A method of producing TCS rich silane gas mixture by hydrogenation of STC in the presence of special MGSI, which has manganese concentration less than 35 ppmw, stably from the FBR of the claim 1 and 2, wherein part of hydrogen is introduced to the fluidized bed reactor through the carrier gas feeding line at ambient temperature.

14. A method of producing TCS rich silane gas mixture by hydrogenation of STC in the presence of special MGSI, which has manganese concentration less than 35 ppmw, stably from the FBR of the claim 1 and 2, wherein part of STC is introduced to the fluidized bed reactor through the carrier gas feeding line at ambient temperature.

15. A method of producing TCS rich silane gas mixture by hydrogenation of STC in the presence of special MGSI, which has manganese concentration less than 35 ppmw, stably from the FBR of the claim 1 and 2, wherein the end of the MGSI feeding line is embedded just under the upper surface of the initially charging material bed with an angle from a vertical line, which is extended from the wall of the lower reactor section, of 20 degrees.

16. A method of producing TCS rich silane gas mixture by hydrogenation of STC in the presence of special MGSI, which has manganese concentration less than 35 ppmw, stably from the FBR of the claim 1 and 2, wherein a recycling line from the cyclone reaches a point, just below the upper end of the lower reactor section, with an angle from a vertical line of 20 degrees.

17. A method of producing TCS rich silane gas mixture by hydrogenation of STC in the presence of special MGSI, which has manganese concentration less than 35 ppmw, stably from the FBR of the claim 1 and 2, wherein use a chemically inert and physically stable initial charging material to disperse hydrogen and STC and the MGSI.

18. A method of producing TCS rich silane gas mixture by hydrogenation of STC in the presence of special MGSI, which has manganese concentration less than 35 ppmw, stably from the FBR of the claim 1 and 2, wherein use a chemically inert and physically stable initial charging material with nitrogen to disperse hydrogen and STC and the MGSI.

19. A method of producing TCS rich silane gas mixture by hydrogenation of STC in the presence of special MGSI, which has manganese concentration less than 35 ppmw, stably from the FBR of the claim 1 and 2, wherein the initial charging material is quartz powder.

20. A method of producing TCS rich silane gas mixture by hydrogenation of STC in the presence of special MGSI, which has manganese concentration less than 35 ppmw, stably from the FBR of the claim 1 and 2, wherein the initially charging material is amorphous quartz powder.

21. A method of producing TCS rich silane gas mixture by hydrogenation of STC in the presence of special MGSI, which has manganese concentration less than 35 ppmw, stably from the FBR of the claim 1 and 2, wherein the initial charging material is sand.

22. A method of producing TCS rich silane gas mixture by hydrogenation of STC in the presence of special MGSI, which has manganese concentration less than 35 ppmw, stably from the FBR of the claim 1 and 2, wherein the initially charging material is non-porous silica powder.

23. A method of producing TCS rich silane gas mixture by hydrogenation of STC in the presence of special MGSI, which has manganese concentration less than 35 ppmw, stably from the FBR of the claim 1 and 2, wherein the initially charging material porous silica powder.

24. A method of producing TCS rich silane gas mixture by hydrogenation of STC in the presence of special MGSI, which has manganese concentration less than 35 ppmw, stably from the FBR of the claim 1 and 2, wherein the initial charging material is glass beads.

25. A method of producing TCS rich silane gas mixture by hydrogenation of STC in the presence of special MGSI, which has manganese concentration less than 35 ppmw, stably from the FBR of the claim 1 and 2, wherein the initial charging material is zirconia powder.

26. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the brim of the gas distribution plate is two.

27. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the brim of the gas distribution plate is four.

28. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the brim of the gas distribution plate is six.

29. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the brim of the gas distribution plate is twelve.

30. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the height of the FBR is two.

31. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the height of the FBR is three.

32. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the height of the FBR is four.

33. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the height of the FBR is five.

34. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the height of the FBR is six.

35. A method of producing TCS rich silane gas mixture by hydrogenation of STC in the presence of special MGSI, which has manganese concentration less than 35 ppmw, stably from the FBR of the claim 1 and 2, wherein the number of thermo-couples installed along the height of the FBR is twelve.

36. A method of producing TCS rich silane gas mixture by hydrogenation of STC in the presence of special MGSI, which has manganese concentration less than 35 ppmw, stably from the FBR of the claim 1 and 2, wherein the reaction bed temperature is controlled between 300° C. to 600° C., more specifically at 550° C., within the mean temperature deviation, between thermo couples in the bed, of ±5° C.,
and
the reaction pressure is controlled between 3 to 10 bars, more specifically at 5 bar,
and
retention time of the STC and hydrogen in the reaction bed is controlled shorter than 50 seconds, more specifically 10 seconds.
